(19) United States
(12) Patent Application Publication
(10) Pub. No.: US 2021/0294497 A1
(43) Pub. Date: Sep. 23, 2021

(54) STORAGE SYSTEM AND METHOD FOR ANALYZING STORAGE SYSTEM

(71) Applicant: HITACHI, LTD., Tokyo (JP)

(72) Inventors: Akira DEGUCHI, Tokyo (JP); Kiyomi WADA, Tokyo (JP)

(73) Assignee: HITACHI, LTD., Tokyo (JP)

(21) Appl. No.: 17/016,971

(22) Filed: Sep. 10, 2020

(30) Foreign Application Priority Data
Mar. 19, 2020 (JP) 2020-049126

(51) Int. Cl. G06F 3/06; G06F 12/0804

(52) U.S. Cl. CPC G06F 3/065; G06F 3/0604; G06F 2212/60; G06F 12/0804; G06F 3/0673

(57) ABSTRACT

A storage system includes a plurality of storage systems and an analysis server. The analysis server analyzes and outputs an information of a storage system to another storage system based on information of the storage system and information of the other storage system which cooperates with the storage system.

### BACKGROUND OF THE INVENTION

### 1. Field of the Invention

The present invention relates to a storage system and a method for analyzing the storage system.

### 2. Description of the Related Art

For large-scale systems such as business systems, it is required to reduce costs for operation management and improve availability by promptly responding to problems. From such a background, it is received a lot of attention on a technique of collecting and analyzing operation information and configuration information of a storage, and speeding up and facilitating storage maintenance and troubleshooting. As an example of such a technique, in JP 2007-48325 A, there is disclosed a method for selecting a parity group of a creation destination of a new volume from a required performance of the volumes forming the parity group and the operation rate of the parity group when a volume, which is a storage area recognized by a host, is newly created.

### SUMMARY OF THE INVENTION

However, as compared to the analysis of an influence on other volumes that share resources within the storage, the configuration change of one storage may affect the performance of the other storage in the remote copy configuration between the storages. Therefore, it is difficult to analyze the influence on the other storage and the cause analysis also takes time.

The invention has been made in view of the above circumstances, and an object of the invention is to provide a storage system and a method for analyzing the storage system capable of efficiently performing an influence analysis between a plurality of storages.

To achieve the above object, a storage system according to a first aspect includes a first storage system that includes a first processor and a first drive, a second storage system that includes a second processor and a second drive, and an analysis device that is capable of communication. The analysis device analyzes an influence of the first storage system on the second storage system based on information of the first storage system and information of the second storage system that cooperates with the first storage system.

According to the invention, it is possible to improve the efficiency of an influence analysis among a plurality of storages.

### BRIEF DESCRIPTION OF THE DRAWINGS

FIG. 1 is a block diagram illustrating a schematic configuration of a storage system according to a first embodiment;

FIG. 2 is a block diagram illustrating an asynchronous remote copy method between the storage systems of FIG. 1;

FIG. 3 is a block diagram illustrating an exemplary hardware configuration of the storage system of FIG. 1;

FIG. 4 is a block diagram illustrating a configuration example of a memory of FIG. 3;

FIG. 5 is a block diagram illustrating an exemplary hardware configuration of an analysis server of FIG. 1;

FIG. 6 is a diagram illustrating a configuration example of a resource table of FIG. 5;

FIG. 7 is a diagram illustrating a configuration example of an IO information table of FIG. 5;

FIG. 8 is a diagram illustrating a configuration example of a configuration information table of FIG. 5;

FIG. 9 is a diagram illustrating a configuration example of a copy performance table of FIG. 5;

FIG. 10 is a diagram illustrating a configuration example of a connection storage table of FIG. 5;

FIG. 11 is a diagram illustrating a configuration example of a synchronous copy response time table of FIG. 5;

FIG. 12 is a flowchart illustrating the processes of a write program and a remote copy program of FIG. 4;

FIG. 13 is a flowchart illustrating the processes of an information transmission program and an information receiving program of FIG. 4;

FIG. 14 is a flowchart illustrating the process of a copy performance change detection program of FIG. 5;

FIG. 15 is a flowchart illustrating the process of an influence analysis program of FIG. 5;

FIG. 16 is a flowchart illustrating the process of a synchronous copy influence analysis program of FIG. 5; and

FIG. 17 is a diagram illustrating a display screen example by a GUI program of FIG. 5.

### DESCRIPTION OF THE PREFERRED EMBODIMENTS

Embodiments will be described with reference to the drawings. Further, the embodiments described below do not limit the scope of the invention. Not all the elements and combinations thereof described in the embodiments are essential to the solution of the invention.

In the following description, a process may be described with the term “program” as the subject, but the program is executed by a processor (for example, a CPU (Central Processing Unit)), and a predetermined process is appropriately performed while using a storage resource (for example, memory) and/or a communication interface (for example, port). Therefore, the subject of the process may be the program. The process described with the program as the subject may be a process performed by a processor or a computer having the processor.

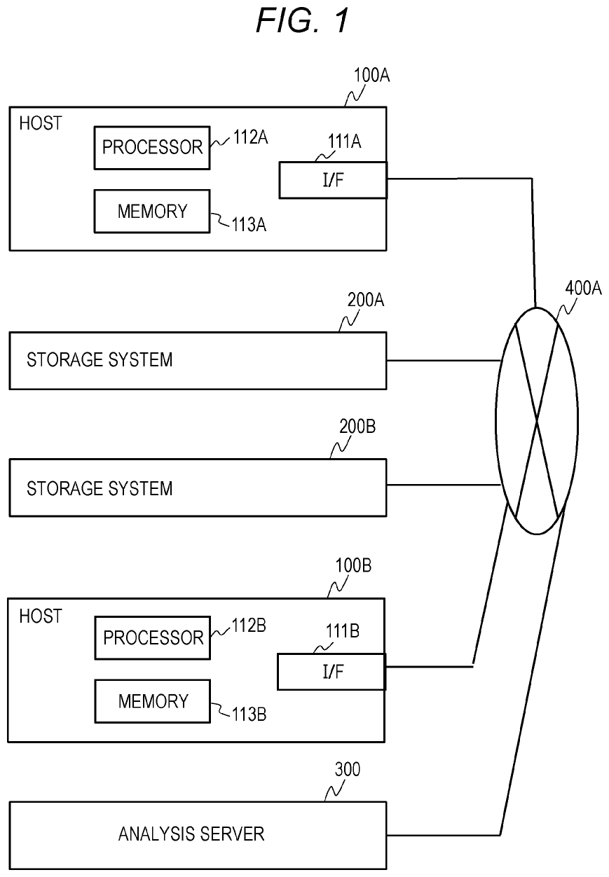

FIG. 1 is a block diagram illustrating a schematic configuration of a storage system according to a first embodiment.

In FIG. 1, the storage system includes a plurality of storage systems 200A and 200B and an analysis server 300. Hosts 100A and 100B, storage systems 200A and 200B, and analysis server 300 are communicatively connected via a network 400A. At this time, the storage systems 200A and 200B can cooperate with each other. As the cooperative operation between the storage systems 200A and 200B, a remote copy can be exemplified. The cooperative operation between the storage systems 200A and 200B may be data migration. The storage systems 200A and 200B may cooperate with each other to construct a distributed file system. Although the example of FIG. 1 illustrates the case where there are two storage systems 200A and 200B, there may be three or more storage systems. In the example of FIG. 1, the hosts 100A and 100B, the storage systems 200A and 200B, and the analysis server are connected to the network 400A, but may be configured using a plurality of networks. The communication means may be different.

The hosts 100A and 100B execute, for example, an IO request (data read request or write request) to the storage systems 200A and 200B, respectively. The storage systems 200A and 200B execute an IO process in response to the IO request from the hosts 100A and 100B, respectively. At this time, the storage systems 200A and 200B provide a capacity in the hosts 100A and 100B via the network 400A, respectively.

The hosts 100A and 100B include host I/Fs 111A and 111B, processors 112A and 112B, and memories 113A and 113B, respectively.

The host I/Fs 111A and 111B are hardware having a function of controlling communication between the hosts 100A and 100B and the outside, respectively. The processors 112A and 112B are hardware that controls the overall operation of the hosts 100A and 100B, respectively. The hosts 100A and 100B include one or more processors 112A and 112B. The one or more processors may be another type of processor such as a GPU (Graphics Processing Unit). One or more processors may be a single core or a multicore. One or more processors may be a processor such as a hardware circuit (for example, an FPGA (Field-Programmable Gate Array) or an ASIC (Application Specific Integrated Circuit)) which performs some or all of the processes in a broad sense. Each of the memories 113A and 113B can be configured by a semiconductor memory such as an SRAM (Static Random Access Memory) or a DRAM (Dynamic Random Access Memory). The memories 113A and 113B can store a program being executed by the processors 112A and 112B, or can be provided with a work area for the processors 112A and 112B to execute a program, respectively. The hosts 100A and 100B may be physical computers, virtual machines, or containers.

The analysis server 300 detects a change in the state of the storage system 200B, analyzes the state of the storage system 200A based on the detection result of the change in the state of the storage system 200B, and outputs the analysis result of the state of the storage system 200A. At this time, the analysis server 300 estimates the influence of the change in the state of the storage system 200B on the processing of the storage system, and outputs the estimation result of the influence on the processing of the storage system 200A. For example, the analysis server 300 manages the configuration of the storage system 200B and the operation rate of resources, estimates the operation rate of the resources of the storage system 200A based on the detection result of the change in the configuration of the storage system 200B or the operation rate of the resources, and estimates an influence on the processing performance of the storage system 200A based on the estimation result of the operation rate of the resources of the storage system 200A.

In addition, the analysis server 300 can collect and analyze configuration information and operation information of an IT infrastructure, and provide feedback to the storage systems 200A and 200B (or storage administrator) or notify an alert.

Further, the analysis server 300 provides a portal, and the provider of the portal can confirm the influence at the time of changing the configuration (for example, increasing a load). The provider can also use this function to confirm the effectiveness of the countermeasure when a trouble occurs. The analysis server 300 may also serve as a management server that performs operations such as creating a volume that is a storage area recognized by the host and checking the operation result.

The analysis server 300 may be disposed on a cloud or in a data center of a storage vendor so as to be connected to a plurality of devices of a plurality of customers. Alternatively, the analysis server 300 may be disposed at a customer site and connected only to the storage at the customer site. The analysis server 300 may be composed of a plurality of servers. The analysis server 300 may be a physical computer, a virtual machine, a container, or the like. The analysis server 300 may be disposed in a plurality of clouds or data centers, and may perform processing such as analysis in a distributed manner.

Hereinafter, the storage systems 200A and 200B and the analysis server 300 of FIG. 1 will be described in more detail. In the following description, remote copy is taken as an example of the cooperative operation between the storage systems 200A and 200B.

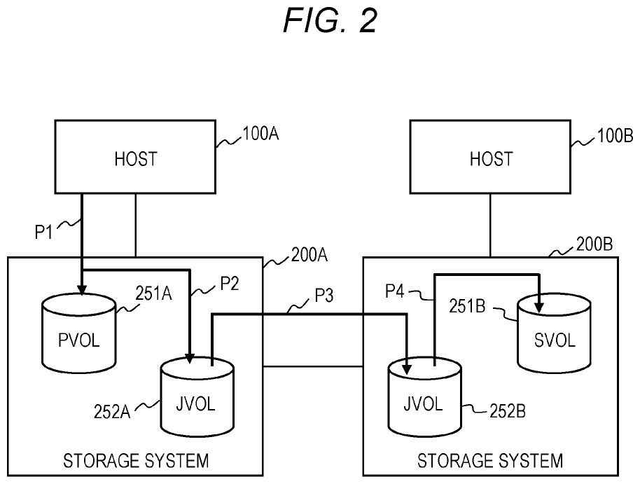

FIG. 2 is a block diagram illustrating an asynchronous remote copy method between the storage systems of FIG. 1. Further, in FIG. 2, the case where the storage system 200A operates as a copy source and the storage system 200B operates as a copy destination is described as an example. In FIG. 2, an asynchronous remote copy is taken as an example, but this embodiment is applicable even in the case of a synchronous remote copy. An example of the remote copy method will be described with reference to FIG. 2, but the invention can be applied to a remote copy method other than the method described. In FIG. 2, the storage system 200A includes a primary volume 251A and a journal volume 252A. The storage system 200B includes a secondary volume 251B and a journal volume 252B. In the example of FIG. 2, the primary volume 251A is a storage area recognized by the host 100A, and the secondary volume 251B is a storage area recognized by the host 100B.

The primary volume 251A holds write data of the copy source. The journal volume 252A temporarily holds the write data before transfer as a journal. The journal includes metadata (write location, write order, address information on journal volume, etc.) in addition to the write data. The secondary volume 251B holds the data transferred from the storage system 200A. The journal volume 252B temporarily holds the transferred write data as a journal.

Then, upon receiving the write request from the host 100A, the storage system 200A stores the write data designated by the write request in the primary volume 251A (P1). Then, the storage system 200A stores the write data stored in the primary volume 251A as a journal in the journal volume 252A (P2), and returns a completion report to the host 100A.

After returning the completion report to the host 100A, the storage system 200A asynchronously transfers the data stored in the journal volume 252A to the journal volume 252B of the storage system 200B (P3). The storage system 200B temporarily holds the data transferred from the storage system 200A as a journal in the journal volume 252B, and stores the write data temporarily held in the journal volume 252B in the secondary volume 251B (P4).

At this time, the storage system 200A manages the other storage and the other volume to which the write data is transferred, as control information. For example, the storage system 200A manages a storage number of the storage system 200B which is the other storage, a correspondence table for managing that the primary volume 251A and the secondary volume 251B are a pair, sequence number information for managing an order of a plurality of write requests to the primary volume 251A, and the number of the journal volume 252A which is the storage destination of the journal created for writing to the primary volume 251A.

Here, the storage system 200A includes a cache, and when there is no line failure, the journal may be stored in the cache. In the case of a line failure or when a write amount to the journal volume 252A exceeds a transfer amount from the journal volume 252A to the journal volume 252B, a journal amount retained in the storage system 200A increases. At this time, since the cache capacity of the storage system 200A is insufficient, a journal is written from the cache to a physical drive which is a physical storage area. This process is called a destage process. In the process of transferring a journal to the storage system 200B, it is necessary to read the journal from the physical drive. This process is called a staging process. As a criterion for determining the shortage of the cache capacity, not only the remaining capacity ratio of 0% but also the remaining capacity ratio falling below a predetermined threshold may be used.

When the storage system 200A performs the destaging to the physical device and the staging from the physical device, the load on the processor of the storage system 200A increases, and the IO performance decreases. Further, the transfer amount from the journal volume 252A to the journal volume 252B is affected by the configuration change of the storage systems 200A and 200B or the operation rate of the resource.

Therefore, the analysis server 300 manages the configurations and the operation rate of the resources of the storage systems 200A and 200B, estimates a copy rate in the remote copy based on the detection results of changes in the configurations of the storage systems 200A and 200B or the operation rate of the resources, estimates the operation rate of the resources of the other storage systems 200B and 200A based on the copy rate in the remote copy, and estimates an influence on the processing performance of the storage systems 200B and 200A. Then, the analysis server 300 can effectively perform the influence analysis between the storage systems 200A and 200B by outputting the estimation result of the influence on the processing performance of the storage systems 200B and 200A.

In addition to the asynchronous remote copy method described above, instead of using the sequence number, the storage system 200A may employ a method of managing the newly written data for a certain period of time (for example, 1 minute) as differential data and regularly transferring the differential data to the storage system 200B. The differential data can be stored in an area such as a journal volume. At this time, the storage system 200A prevents the new write during transfer from overtaking the transfer data by dividing the journal volume for storing the data during transfer and for the new write. When writing is performed a plurality of times at the same address in a certain period of time, the transfer amount can be reduced by managing only the last written data as differential data. Further, it is also possible to manage an address where data is newly written in a certain period of time, store the data in the primary volume 251A, and directly transfer the data from the primary volume 251A to the storage system 200B. In this case, the differential data is stored in another area such as a journal volume only when writing is performed a plurality of times at the same address in a certain period of time. Therefore, the capacity for managing the differential data can be reduced.

Next, the synchronous remote copy will be described. The synchronous remote copy is a method of transferring the write data to the storage system 200B that is the copy destination in synchronization with IO from the host. In the case of the synchronous remote copy, the journal volumes 252A and 252B are unnecessary. At this time, the storage system 200A stores the write data designated by the write request from the host 100A in the primary volume 251A, writes the data stored in the primary volume 251A to the secondary volume 251B, and reports the completion to the host 100A.

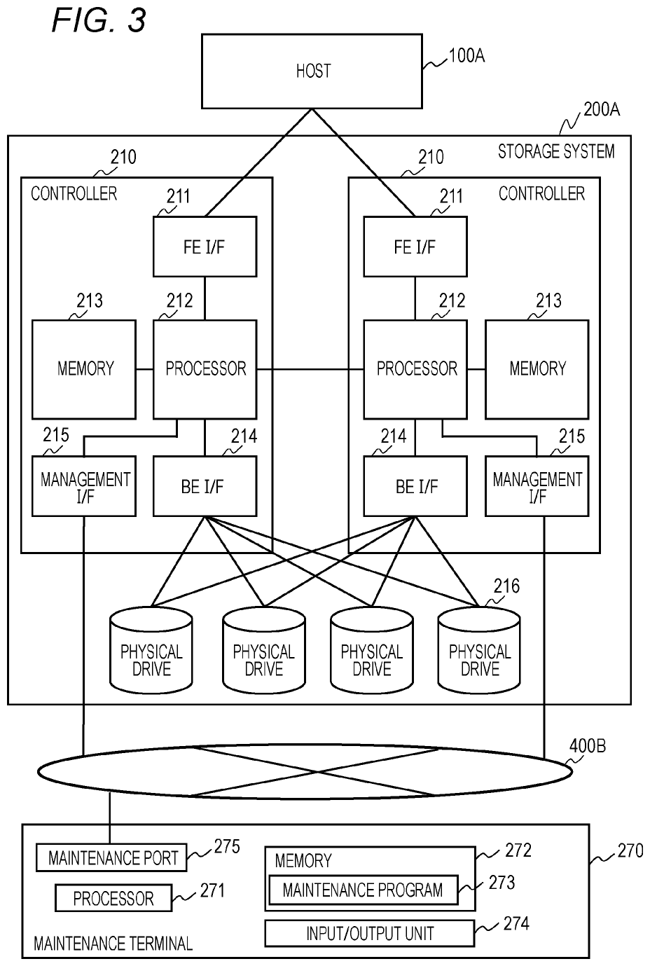

FIG. 3 is a block diagram illustrating an exemplary hardware configuration of the storage system of FIG. 1. While FIG. 3 illustrates a configuration example of the storage system 200A in FIG. 1, the storage system 200B can also be configured in the same manner as the storage system 200A.

In FIG. 3, the storage system 200A includes a controller 210 and a physical drive 216. The storage system 200A is connected to a maintenance terminal 270 via a network 400B.

The controller 210 includes a front-end I/F 211, a processor 212, a memory 213, a back-end I/F 214, and a management I/F 215. Further, in FIG. 3, two controllers 210 are mounted to improve redundancy, but three or more controllers 210 may be mounted. In that case, when one controller 210 fails, the other controller 210 takes over the process executed by the failed controller 210. Further, the controller 210 does not have to be duplicated.

The controller 210 processes the request from the host 100A, and controls the physical drive 216. The front-end I/F 211 is an interface that communicates with the host 100A. The processor 212 controls the entire controller 210. The memory 213 stores programs and data used by the processor 212. The memory 213 also stores a cache of data stored in the physical drive 216. The back-end I/F 214 is an interface that communicates with the physical drive 216. The management I/F 215 is an interface that communicates with the maintenance terminal 270. The physical drive 216 is a device having a non-volatile data storage medium, and may be, for example, an SSD (Solid State Drive) or an HDD (Hard Disk Drive). Other storage devices such as SCM (Storage Class Memory) may be used. One or more physical drives 216 may be grouped in a unit called a parity group, and a high reliability technology such as RAID (Redundant Arrays of Independent Disks) may be used.

The storage system 200A creates a volume using the physical drive 216. The volume is associated with the physical drive 216. Data of one volume may be stored in a plurality of physical drives forming a parity group. Although a predetermined area of the volume and a predetermined area of the physical drive 216 are associated with each other, the concept of a capacity pool may be introduced between the volume and the physical drive 216. The cost can be reduced by allocating the capacity from the capacity pool only to the area where the volume is written. This technique is called thin provisioning.

The maintenance terminal 270 performs initial setting of the physical drive 216 of the storage system 200A, installation of a program executed by the processor 212, creation of a volume affecting the host, displaying of operation information and alerts, and the like. The maintenance terminal 270 includes a processor 271, a memory 272, an input/output unit 274, and a maintenance port 275.

The processor 271 controls the entire maintenance terminal 270. The memory 272 stores a maintenance program 273 executed by the processor 271. The input/output unit 274 receives data input to the maintenance terminal 270, and displays the maintenance status at the maintenance terminal 270. The maintenance port 275 is a port used for communication with the storage system 200A.

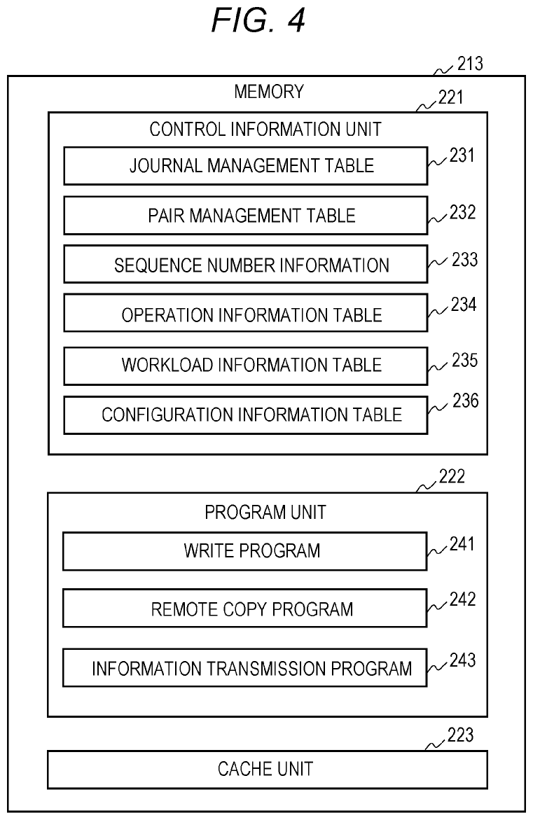

FIG. 4 is a block diagram illustrating a configuration example of the memory 213 of FIG. 3.

In FIG. 4, the memory 213 includes a control information unit 221 which stores control information, a program unit 222 which stores programs, and a cache unit 223 which caches data.

The control information unit 221 includes a journal management table 231, a pair management table 232, sequence number information 233, an operation information table 234, a workload information table 235, and a configuration information table 236. The program unit 222 includes a write program 241, a remote copy program 242, and an information transmission program 243.

The pair management table 232 manages the relationship between a primary volume and a secondary volume. Since a volume number given to the volume is unique only within the storage system, the pair management table 232 of the storage system 200A having the primary volume has the storage number of the storage system 200B and the volume number of the secondary volume. The pair management table 232 of the storage system 200B having the secondary volume has the storage number of the storage system 200A and the volume number of the primary volume. In addition, the copy status such as copy stop and copying may be managed.

The sequence number information 233 is information for managing the order of write requests written from the host 100A. Number information is stored in the sequence number information 233. When a write request is received from the host 100A, a number is allocated from the sequence number information 233 and the sequence number information 233 is increased. In the case of asynchronous remote copy that guarantees the write order in a unit of I/O, the storage system manages the order of data transfer using sequence numbers.

The journal management table 231 manages a primary volume group which shares the relationship between the primary volume and the secondary volume along with the sequence number. When maintaining the write order in a plurality of primary volumes, the storage system manages the plurality of primary volumes as a consistency group, and sets one sequence number in the group.

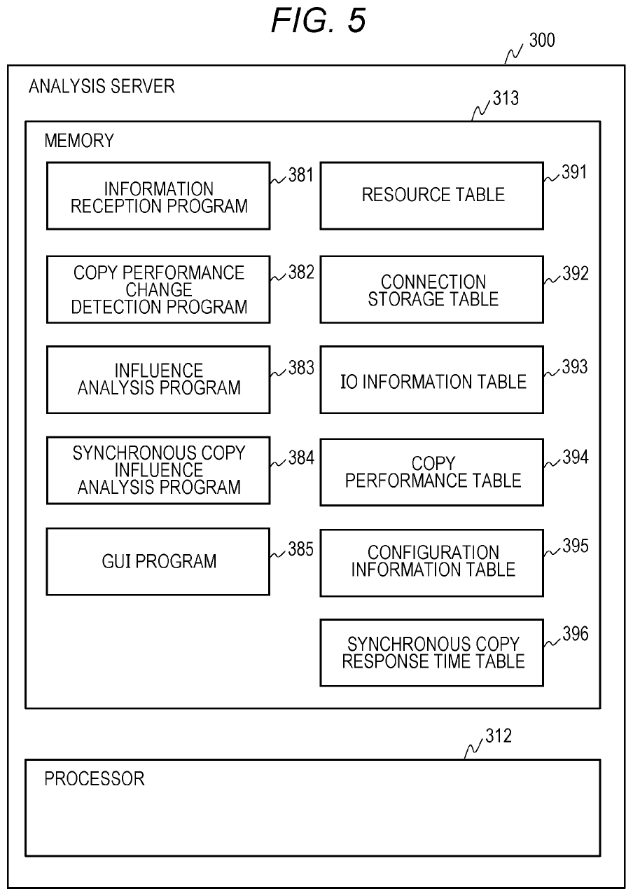

The operation information table 234 stores operation information of the storage system 200A. The operation information table 234 is held for each of the storage systems 200A and 200B. In each of the storage systems 200A and 200B, the information transmission program 243 transmits the information of the operation information table 234 to the analysis server 300, and the analysis server 300 stores this information time-sequentially in the resource table 391 of FIG. 5.

The workload information table 235 stores IO information of the storage system 200A. The workload information table 235 is held for each of the storage systems 200A and 200B. In each of the storage systems 200A and 200B, the information transmission program 243 transmits the information in the workload information table 235 to the analysis server 300, and the analysis server 300 stores this information time-sequentially in the IO information table 393 in FIG. 5.

The configuration information table 236 stores the configuration information of the storage system 200A. The configuration information table 236 is held for each of the storage systems 200A and 200B. In each of the storage systems 200A and 200B, the information transmission program 243 transmits the information of the configuration information table 236 to the analysis server 300, and the analysis server 300 stores this information time-sequentially in the configuration information table 395 of FIG. 5.

FIG. 5 is a block diagram illustrating an exemplary hardware configuration of the analysis server 300 of FIG. 1.

In FIG. 5, the analysis server 300 includes a processor 312 and a memory 313. The analysis server 300 may be a VM (Virtual Machine) or a container.

The processor 312 is hardware that controls the operation of the entire analysis server 300. The processor 312 may be a CPU (Central Processing Unit) or a GPU (Graphics Processing Unit). The processor 312 may be a single core processor or a multi core processor. The processor 312 may include a hardware circuit (for example, FPGA (Field-Programmable Gate Array) or an ASIC (Application Specific Integrated Circuit)) such as an accelerator that performs part of the process. The processor 312 may operate as a neural network.

The memory 313 stores an information receiving program 381, a copy performance change detection program 382, an influence analysis program 383, a synchronous copy influence analysis program 384, a GUI (Graphical User Interface) program 385, a resource table 391, a connection storage table 392, an IO information table 393, a copy performance table 394, a configuration information table 395, and a synchronous copy response time table 396. The GUI program 385 displays the result of the influence of the other storage system on the own storage system and the content of the configuration change of the target storage.

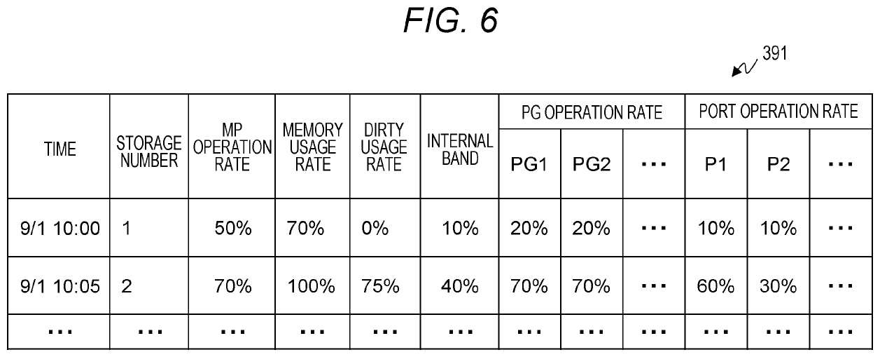

FIG. 6 is a diagram illustrating a configuration example of the resource table 391 of FIG. 5.

In FIG. 6, the resource table 391 stores time-sequentially the operation results of resources collected from each storage system connected to the analysis server 300 of FIG. 5.

The resource table 391 includes entries of time, storage number, MP operation rate, memory usage rate, dirty usage rate, internal band, PG operation rate, and port operation rate. The resource table 391 may also manage information on resources other than these resources.

The time indicates the collection time of the operation results of the resources collected from each storage system. The storage number indicates a number that uniquely identifies each storage system. The MP operation rate indicates the operation rate of the processor of each storage system. The memory usage rate indicates the usage rate of the memory of each storage system. The dirty usage rate indicates the cache usage rate due to dirty data. The dirty data means data which is written from the host to the cache and not yet written to the physical drive. The internal band indicates the usage rate of the internal network of each storage system. The PG operation rate indicates the operation rate of the parity group of each storage system. The port operation rate indicates the operation rate of the port of each storage system. As for the MP operation rate, the operation rate of each processor may be managed, or the average operation rate may be used. Further, both the operation rate and the average of each processor may be managed.

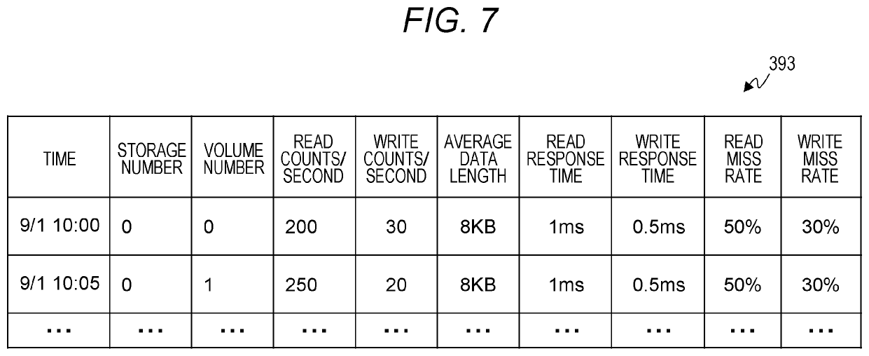

FIG. 7 is a diagram illustrating a configuration example of the IO information table 393 of FIG. 5.

In FIG. 7, the IO information table 393 stores time-sequentially the IO results collected from each storage system connected to the analysis server 300.

The IO information table 393 includes entries of time, storage number, volume number, read counts/second, write counts/second, average data length, read response time, write response time, read miss rate, and write miss rate. The IO information table 393 may also manage information on resources other than these resources.

The time indicates the collection time of the actual IO results collected from each storage system. The storage number indicates a number that uniquely identifies each storage system. The volume number indicates a number that uniquely identifies the volume of each storage system. As for a volume identified by the storage number and the volume number, the read counts/second, the write counts/second, the average data length, the read response time, the write response time, the read miss rate, and the write miss rate are managed. The read counts/second indicates the number of reads of data per second. The write counts/second indicates the number of writes of data per second. The average data length indicates the average length of IO data. The read response time indicates a response time at the time of reading. The write response time indicates a response time at the time of writing. The read miss rate indicates a rate at which the target data is not in the cache at the time of reading. The write miss rate indicates a rate at which the data of the target address is not in the cache at the time of writing. In the example of FIG. 7, various information such as the read counts/second is held in the unit of volume, but various information may be held in the unit of device if the analysis content is analyzed in the unit of device.

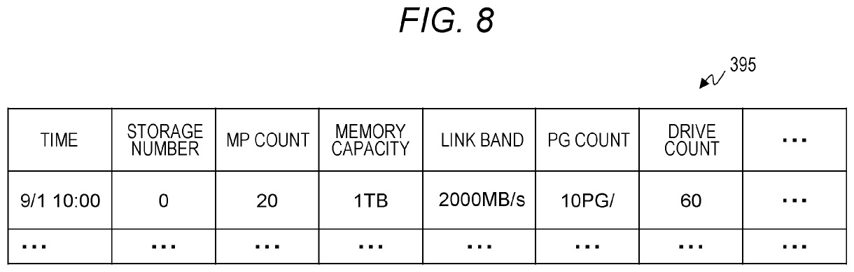

FIG. 8 is a diagram illustrating a configuration example of the configuration information table 395 of FIG. 5.

In FIG. 8, the configuration information table 395 stores time-sequentially the results of the configuration information collected from each storage system connected to the analysis server 300.

The configuration information table 395 includes entries for time, storage number, MP count, memory capacity, link bandwidth, PG count, and drive count. The configuration information table 395 may also manage information on resources other than these resources.

The time indicates the collection time of the configuration information collected from each storage system. The storage number indicates a number that uniquely identifies each storage system. The MP count indicates the number of processors in each storage system. The memory capacity indicates the capacity of the memory of each storage system. The link bandwidth indicates the bandwidth of the link of each storage system at the time of remote copy. The PG count indicates the number of parity groups in each storage system. The drive count indicates the number of physical drives in each storage system. The number of parity groups may be managed for each configuration of parity groups.

The analysis server 300 may change the collection frequency of each information stored in the resource table 391 of FIG. 6, the IO information table 393 of FIG. 7, and the configuration information table 395 of FIG. 8. For example, since the configuration information stored in the configuration information table 395 does not change frequently, it may be collected at a low frequency. Further, the storage system may transmit the configuration information to the analysis server 300 when the configuration is changed.

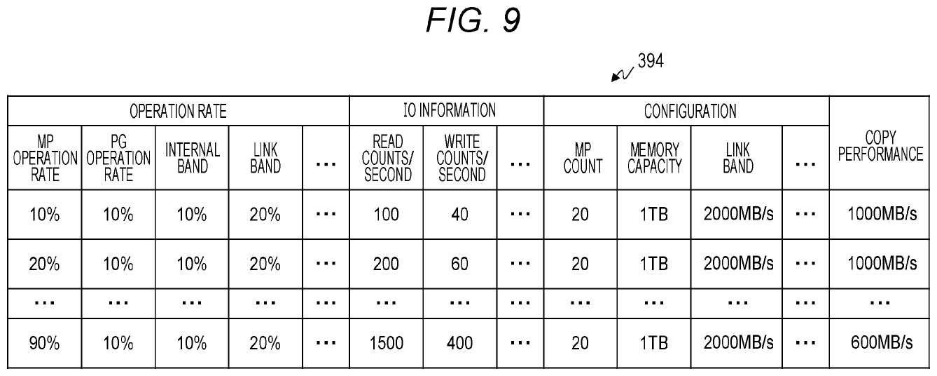

FIG. 9 is a diagram illustrating a configuration example of the copy performance table 394 of FIG. 5. In FIG. 9, the copy performance table 394 stores information for acquiring copy performance from the operation information, IO information, and configuration information of each storage system.

The copy performance table 394 includes, as operation information, entries such as MP operation rate, PG operation rate, internal band, and link bandwidth; as IO information, entries such as the read counts/second and the write counts/second; as configuration information, entries such as MP count, memory capacity, and link bandwidth; and also the entry of copy performance. It may be provided with the read counts/second and the write counts/second of the remote copy application volume, and the read counts/second and the write counts/second of the remote copy non-application volume.

The analysis server 300 can extract the operation information and the configuration information of each storage system from the information of the resource table 391 of FIG. 6, the IO information table 393 of FIG. 7, and the configuration information table 395 of FIG. 8, and can register the information in the copy performance table 394. When the remote copy application volume includes read counts/second and write counts/second, read counts/second and write counts/second of the remote copy application volume can be calculated using the information in the pair management table in FIG. 4 in addition to the above information.

The copy performance indicates the number of bytes copied per unit time. The copy performance may decrease due to changes in the processor idle waiting time or the like, and the processing method may change depending on the MP operation rate or the configuration as the logic inside the storage system. The analysis server 300 records, in the copy performance table 394, a record of what copy performance has been achieved in the past based on such changes.

The analysis server 300 may count the result of copy performance for each frequent operation rate and configuration to record a maximum copy performance, or learn the copy performance using a method such as machine learning. Instead of using the information collected from each storage system, the copy performance in various configurations may be measured in advance, and the configuration information and the copy performance may be stored in the copy performance table 394 in advance. Further, the pattern of the configuration information and the copy performance may be added at any time. Further, although the configuration information and the copy performance are stored in advance, the table content may be updated or added using the information collected from each storage system.

The analysis server 300 may create the copy performance table 394 for each storage system, or may create one copy performance table 394 from the information of all storage systems connected to the analysis server 300.

It is practically difficult to collect all the small differences such as the operation rates and configuration information of all storage systems and use the differences for learning. If learning is performed for each storage system, it is possible to avoid a difference in copy performance due to such a difference, and improve the accuracy of copy performance.

When learning is performed for all storage systems, more learning patterns can be acquired, so the copy performance can be predicted even when a configuration change that results in the patterns of the operation rate and the configuration which have not occurred so far.

In the example of FIG. 9, the method of calculating the copy performance from various operation rates such as the processor, the parity group, and the internal band is illustrated. However, a method may be used in which the copy performance change detection program 382 of FIG. 5 detects the state change of the storage system, specifies a portion that becomes a neck portion of the remote copy, and calculates the copy performance from the operation rate of the neck portion. For example, when the storage system 200B of FIG. 2 creates a new volume, the operation rate of the processor of the storage system 200B changes, and that processor becomes a bottleneck for remote copy, the analysis server 300 may calculate the copy performance from the operation rate and the configuration of the processor.

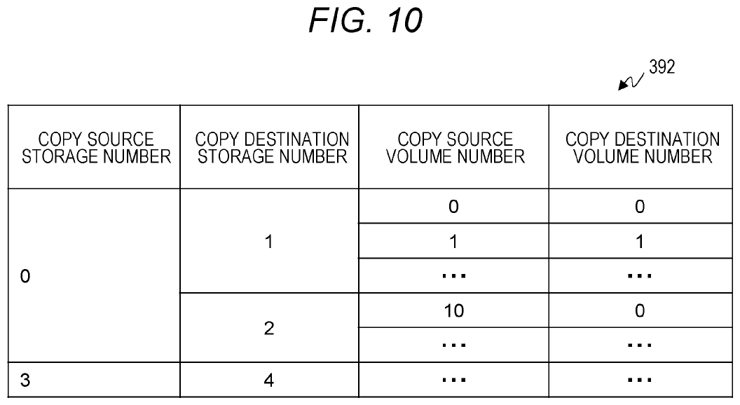

FIG. 10 is a diagram illustrating a configuration example of the connection storage table 392 of FIG. 5.

In FIG. 10, the connection storage table 392 manages which volume of which storage has relation with which volume of another storage.

The connection storage table 392 includes entries of a copy source storage number, a copy destination storage number, a copy source volume number, and a copy destination volume number. The analysis server 300 refers to the connection storage table 392, and when the state of a certain storage system changes in the remote copy or the like, the analysis server 300 can determine the other storage system whose state is affected by the change. Although FIG. 10 illustrates an example of managing the relationship on a volume basis, the relationship may be managed on a storage system basis.

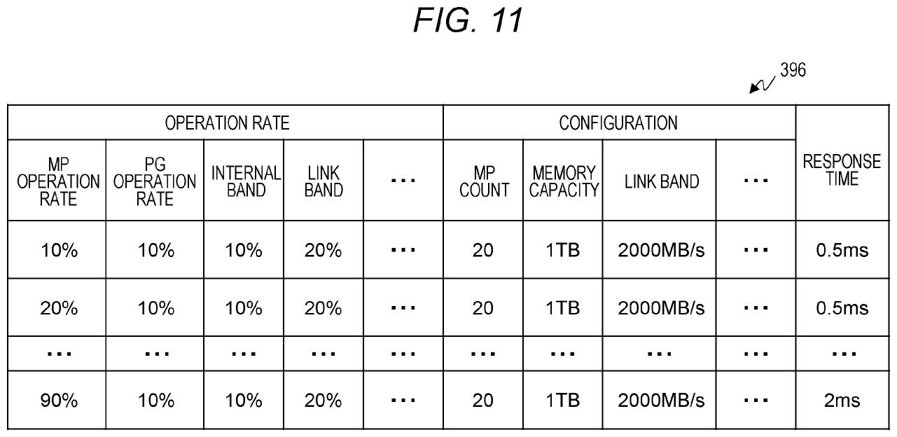

FIG. 11 is a diagram illustrating a configuration example of the synchronous copy response time table 396 of FIG. 5.

The synchronous copy response time table 396 of FIG. 11 includes the entry of a response time instead of the entry of the copy performance of the copy performance table 394 of FIG. 9.

The response time is the time until the storage system 200A receives an IO request from the host and reports the completion of the IO request to the host. The response time is affected by the processing time in the storage system 200A, the network transfer time, and the processing time in the storage system 200B. In the storage systems 200A and 200B, for example, when the operation rate of the processor becomes high, there is a possibility that the processor will wait for a free space and the response time will become long. Similarly, other various resources also affect the response time. In FIG. 11, the operation rate of resources that may affect the response time, the configuration, and the results of the response time are managed.

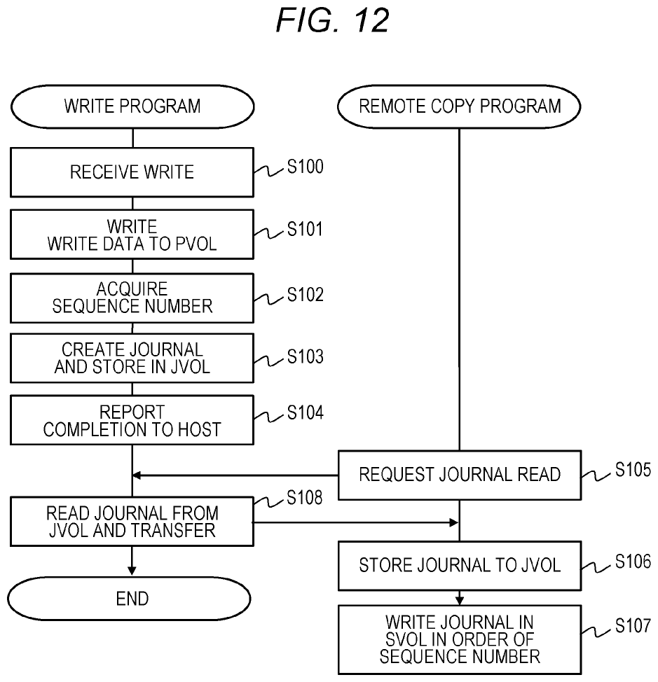

FIG. 12 is a flowchart illustrating the processes of the write program 241 and the remote copy program 242 of FIG. 4. In the example of FIG. 12, the storage system 200A of FIG. 2 executes the write program 241, and the storage system 200B executes the remote copy program 242.

In FIG. 12, when the write program 241 receives a write request from the host 100A (S100), the write data designated by the write request is stored in the primary volume 251A (S101). This saving means storing the write data in the cache. Generally, the process of writing the write data on the cache to the physical drive is executed asynchronously.

Next, the write program 241 acquires the sequence number of the write data (S102), stores the write data saved in the primary volume 251A as a journal in the journal volume 252A (S103), and returns a completion report to the host 100A (S104).

Next, the remote copy program 242 issues a journal read request to the write program asynchronously with the completion report to the host 100A (S105). When receiving the journal read request, the write program 241 transfers the data stored in the journal volume 252A to the journal volume 252B (S108). Step S108 may be executed by another program other than the write program. In that case, the write program 241 ends the process after S104. In the example of FIG. 12, the remote copy program 242 issues a read request to the storage system 200A. However, the write program 241 may issue a write request to the storage system 200B after S104. In that case, the storage system 200B receives the write request and executes S106.

Next, the remote copy program 242 temporarily holds the data transferred from the storage system 200A as a journal in the journal volume 252B (S106), and stores the write data held in the journal volume 252B in the secondary volume 251B in the order of the sequence number (S107). The remote copy program 242 may operate a plurality of processes in parallel. Therefore, a journal having a sequence number smaller than the sequence number of the journal stored in S106 may not arrive at the storage system 200B. In order to wait for the arrival of such a journal having a smaller sequence number, the journal is temporarily stored in the journal volume 252B.

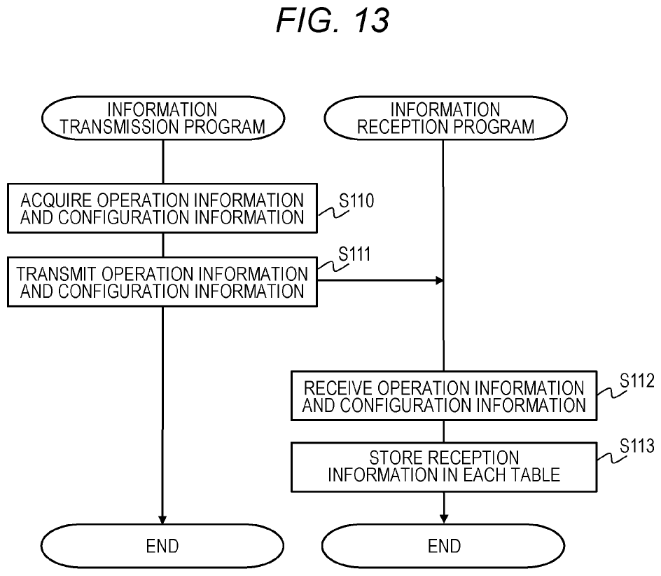

FIG. 13 is a flowchart illustrating the processes of the information transmission program 243 of FIG. 4 and the information receiving program 381 of FIG. 5. Further, the example of FIG. 13 illustrates the case where the storage system 200A of FIG. 2 executes the information transmission program 243 and the analysis server 300 executes the information receiving program 381.

In FIG. 13, the information transmission program 243 acquires the operation information and the configuration information of the storage system 200A (S110), and transmits the information to the analysis server 300 (S111).

Next, the information receiving program 381 receives the operation information and the configuration information of the storage system 200A (S112), and stores the information time-sequentially in the resource table 391 of FIG. 6, the IO information table 393 of FIG. 7, or the configuration information table 395 of FIG. 8 (S113).

The information transmission program 243 may transmit information when it detects a change in the configuration or settings of the storage system 200A (such as when a volume is paired), or periodically transmits information. The information receiving program 381 may change the collecting method and the collection frequency according to the operation information and the configuration information.

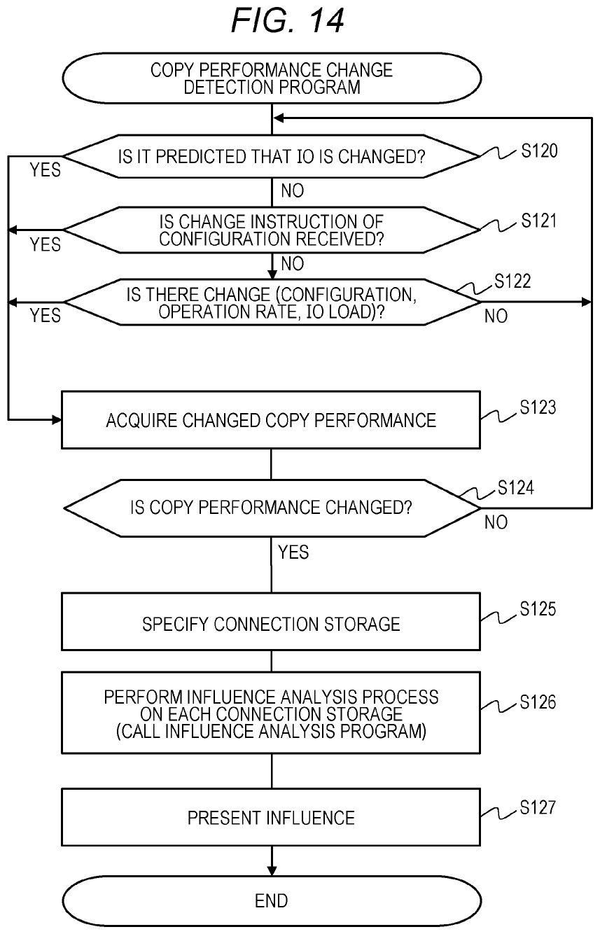

FIG. 14 is a flowchart illustrating the processing of the copy performance change detection program 382 of FIG. 5.

In FIG. 14, the copy performance change detection program 382 predicts a change in the IO load of the target storage system (S120). When there is a change, the process proceeds to S123. When there is no change, the copy performance change detection program 382 checks whether there is a configuration change instruction (S121). When there is a change, the process proceeds to S123. When there is no change, the copy performance change detection program 382 checks whether a change in the configuration information, the operation information, or the IO load has actually occurred (S124). When there is a change, the process proceeds to Step S123. When there is no change, the process returns to Step S120 and the process is repeated from Step S120. The process may return to Step S120 after a fixed time passes. In order to detect the change in S122, various tables illustrated in FIGS. 6, 7, and 8 may be referred to. The change in the configuration information can be easily detected by the difference from the previously collected value. The operation rate of the resource and IO load can be determined by a method or learning that determines whether the difference from the previous time is within a predetermined threshold. In the learning method, past history data is learned, and the operation rate of the resource and the IO load are predicted. When the collected values deviate from the predicted range, it can be detected as a change. This is realized by applying a generally known technique for detecting an abnormal value. Also in the prediction of the change in the IO load in Step S120, the past history data is learned, and the future IO load is predicted.

When a change is detected in Steps S120, S121, and S122, the copy performance change detection program 382 acquires the changed copy performance (S123). When acquiring the copy performance, the copy performance change detection program 382 may refer to the copy performance table 394 of FIG. 9.

Next, the copy performance change detection program 382 determines whether there is a change in copy performance (S124), and when there is no change in copy performance, the process returns to Step S120. On the other hand, when there is a change in copy performance, the connection storage system connected to the target storage system is specified by referring to the connection storage table 392 in FIG. 10 (S125).

Next, the copy performance change detection program 382 calls the influence analysis program 383, and executes an influence analysis process for the connection storage system (S126).

Finally, the copy performance change detection program 382 presents the analysis result, and ends the process (S127). The analysis result is information that includes the influence on another storage system detected in Step S125.

Further, in the configuration change, the operation rate of the resource after the configuration change may be calculated from the change in the number of resources, and used as the change in the operation rate of the resource. For example, when a processor fails or a processor is removed, the copy performance change detection program 382 can also calculate the MP operation rate from the expression: Average operation rate×Number of processors÷Number of remaining processors.

Regarding the configuration change of creating a new volume, the relationship between IOPS (Input/output operations per second) and the MP operation rate is stored or learned in advance. Then, when creating a new volume, the copy performance change detection program 382 causes the requested IOPS of the new volume to be created to be specified, and searches the relationship between the IOPS and the MP operation rate based on the expression: Current IOPS+Specified IOPS. Alternatively, the MP operation rate after creating a volume may be acquired.

When applying a storage function such as snapshot, the copy performance change detection program 382 can calculate the MP operation rate from the expression: Current MP operation rate×(Processing overhead before snapshot application+Snapshot processing overhead)÷Processing overhead before snapshot application=MP overhead after snapshot application. The processing overhead before applying the snapshot is processing overhead due to IO in the primary storage system, and processing for reflecting the journal to the secondary volume in the secondary storage system.

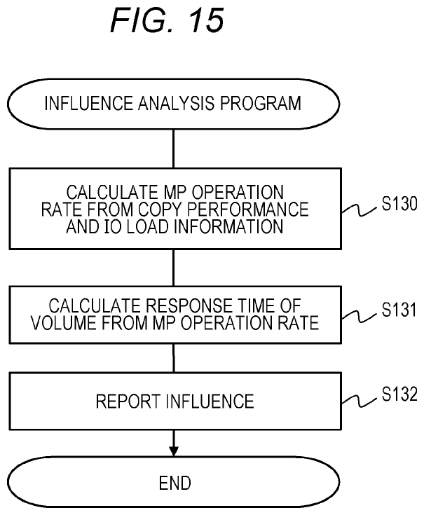

FIG. 15 is a flowchart illustrating the process of the influence analysis program 383 of FIG. 5. In FIG. 15, the influence analysis program 383 refers to the copy performance table 394 of FIG. 9, and calculates the operation rate of the resource of the connection storage system specified in Step S125 of FIG. 14 from the copy performance and the IO information (S130). The copy performance is the value already determined in Step S123 of FIG. 14. The IO information uses read/second and write/second of the volume to which the remote copy function is applied, and the read/second and write/second of the volume to which the remote copy function is not applied. Other information may be used, or the operation rate of the resource may be acquired using less information. In the example of FIG. 9, the IO information includes the read counts/second and the write counts/second. There may be included read counts/second and write counts/second of the remote copy application volume, and read counts/second and write counts/second of the remote copy application volume. A remote copy application status is stored in the pair management table 232 in FIG. 4. The information included in the pair management information can also be realized by collecting the information in the analysis server 300.

Next, the influence analysis program 383 calculates the response time of the volume from the MP operation rate of the connection storage system (S131). The volume referred to here is not only the copy source volume for remote copy, but all volumes including volumes not subject to remote copy. The relationship between the MP operation rate and the response time may be managed in advance. The relationship may be built using functions such as machine learning. It may be calculated from a queue-like model. Next, the influence analysis program 383 reports the analysis result to the calling program (S132).

It is also possible to calculate the MP operation rate. In the case of asynchronous remote copy, when the copy amount is less than the write amount to the primary volume, the journal amount held by the journal volume of the copy source storage system increases. When the journal amount held by the journal volume becomes larger than the cache capacity, the copy source storage system writes to the physical drive (destage process). Further, in the transfer to the copy destination storage system, a read process from the physical drive is required (staging process). Therefore, the processing overhead for destaging to the physical drive and staging increases. Instead of calculating the MP operation rate using the results stored in FIG. 9 as described above, the MP operation rate can be calculated by the following expression.

A=Read/second of non-remote copy volume×Read processing overhead

B=Write/second of non-remote copy volume×Write processing overhead

C=Read/second of remote copy volume×(Read processing overhead of remote copy)

D=Write/second of remote copy volume×(Write processing overhead of remote copy+Destage processing overhead of journal volume)

E=Number of copies/second×(Copy overhead+Staging processing overhead of journal volume)

Then, the MP operation rate after the copy amount changes can be calculated as follows:

New MP operation rate=(A+B+C+D+E)/1 second. In this case, various processing overheads are set in advance, and managed by the storage system and the analysis server. This may be obtained by measuring the value in advance, and may be registered in the storage system and the analysis server via the management server or the maintenance server, or may be incorporated in a program in advance.

In this expression, the destage processing overhead of the journal volume, the staging processing overhead of the journal volume, and the copy counts/second are affected by the state change of the target storage system. The destage processing overhead and the staging processing overhead occur when the copy amount is less than the write amount to the primary volume.

The unit of overhead is seconds (how many seconds the processor uses for the processing).

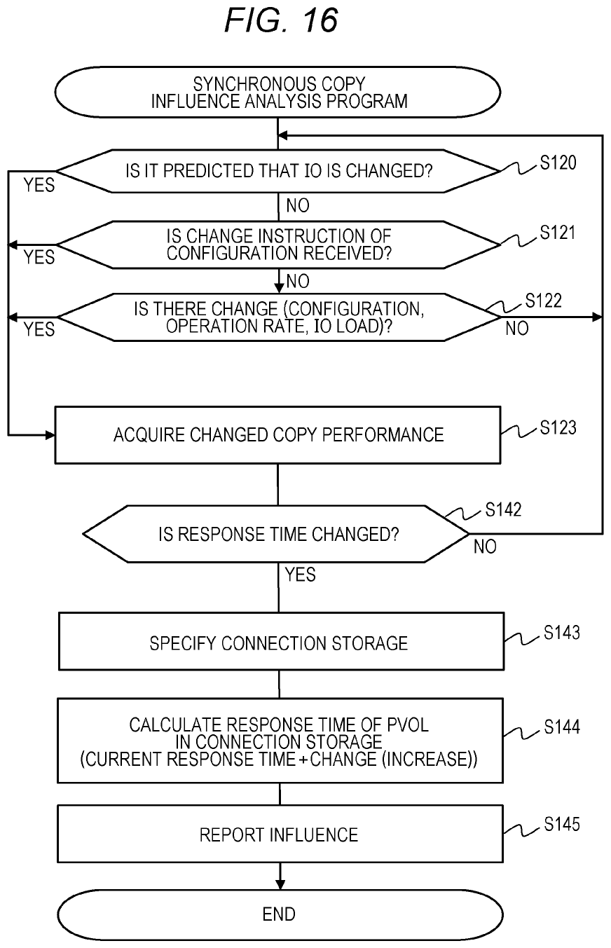

FIG. 16 is a flowchart illustrating the processing of the synchronous copy influence analysis program 384 of FIG. 5.

In FIG. 16, the synchronous copy influence analysis program 384 predicts a change in the IO load, checks the presence/absence of a configuration change instruction, and checks the change (configuration information, operation information, and IO load). When there is a change, the process proceeds to Step S123. When there is no change, the process returns to Step S120. These processes are the same as the processes of FIG. 14.

Next, the synchronous copy influence analysis program 384 refers to the synchronous copy response time table 396 of FIG. 11, and acquires the response time after the change of the operation rate of the resource. Here, in the case of synchronous remote copy, the connection storage system does not use the journal volume as in asynchronous remote copy, but waits for a response from the target storage system. Therefore, when the processing time on the target storage system side increases due to a change in the operation rate of the resource on the target storage system side, the response time to the write request from the connection storage system to the journal volume may increase.

Next, the synchronous copy influence analysis program 384 determines whether there is a change in response time (S142), and when there is no change in response time, the process returns to Step S120. On the other hand, when there is a change in the response time, the connection storage system connected to the target storage system is specified by referring to the connection storage table 392 in FIG. 10 (S143).

Next, the synchronous copy influence analysis program 384 calculates the response time of the primary volume of the connection storage system (S144). At this time, the synchronous copy influence analysis program 384 adds the response time that increases after the change in the operation rate of the resource of the target storage system to the response time of the primary volume of the connection storage system, and can estimate the response time after the influence from the target storage system occurs.

Next, the influence analysis program 383 reports the influence on the connection storage system (S145). The influence on the connection storage system is, for example, the response time after the influence from the target storage system occurs.

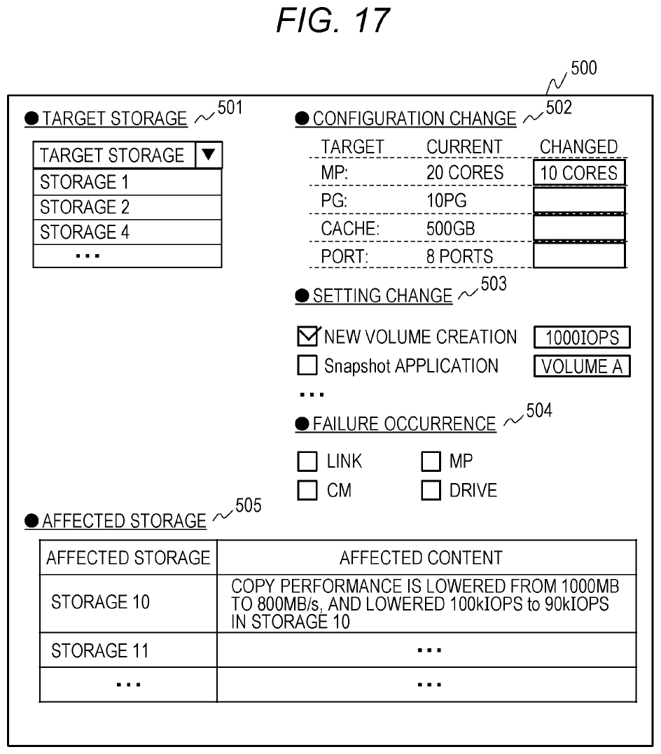

FIG. 17 is a diagram illustrating a display screen example by the GUI program 385 of FIG. 5.

In FIG. 17, the display screen 500 includes display fields for a target storage 501, a configuration change 502, a setting change 503, a failure occurrence 504, and an affected storage 505.

The target storage 501 displays the candidate of the influencing storage system. The configuration change 502 displays the current state of the processor, the parity group, the cache, and the port, and the changed configuration. The setting change 503 displays setting information such as new volume creation and snapshot application. The failure occurrence 504 displays a failure occurrence location such as a processor, a link, or a drive. The affected storage 505 displays the affected storage system and the affected content.

Then, the user launches a browser on the user terminal to access the analysis server 300. Then, the GUI program 385 displays the display screen 500 on the user terminal. When the user selects the target storage on the display screen 500, the GUI program 385 displays the influence content of the affected storage according to the configuration change of the target storage, the setting change, or the failure occurrence. This allows the user to check how the configuration change of a certain storage affects the performance of other storage. The influence on other storages can be easily analyzed, and the time taken for analyzing causes can be shortened.

Further, the invention is not limited to the above embodiments, but various modifications may be contained. For example, the above-described embodiments of the invention have been described in detail in a clearly understandable way, and are not necessarily limited to those having all the described configurations. In addition, some of the configurations of a certain embodiment may be replaced with the configurations of the other embodiments, and the configurations of the other embodiments may be added to the configurations of the subject embodiment. In addition, some of the configurations of each embodiment may be omitted, replaced with other configurations, and added to other configurations. Each of the above configurations, functions, processing units, processing means, and the like may be partially or entirely achieved by hardware by, for example, designing by an integrated circuit.

What is claimed is:

1. A storage system, comprising:
a first storage system that includes a first processor and a first drive;
a second storage system that includes a second processor and a second drive; and
an analysis device that is capable of communication, wherein
the analysis device analyzes an influence of the first storage system on the second storage system based on information of the first storage system and information of the second storage system that cooperates with the first storage system.

2. The storage system according to claim 1, wherein
the cooperative operation is remote copy from the second storage system to the first storage system.

3. The storage system according to claim 2, wherein
the second storage system is configured to
transmit processed IO data to the first storage system by the remote copy,
store the transmitted data to a cache, read the data from the cache, and delete the data after transmission, and
store the transmitted data to the first drive when a capacity of the cache is insufficient, and read the data from the first drive and transmit the data.

4. The storage system according to claim 2, wherein
the analysis device specifies the second storage system affected by the first storage system based on a relationship between storage systems in which the remote copy is set.

5. The storage system according to claim 4, wherein
an influence of a plurality of second storage systems on one first storage system is analyzed based on the relationship between the storage systems.

6. The storage system according to claim 2, wherein
the analysis device is configured to
estimate a remote copy performance based on the information of the first storage system, and
estimate an influence on a processing performance of the first storage system based on the estimated remote copy performance.

7. The storage system according to claim 6, wherein
the information of the storage system includes configuration information and an operation rate of a resource,
a remote copy performance is estimated based on the configuration information and the operation rate of the first storage system, and
an influence on a processing performance of the second storage system is estimated based on the estimated remote copy performance and the configuration information and the operation rate of the first storage system.

8. The storage system according to claim 7, wherein
when the remote copy performance deteriorates, the second storage system is affected.

9. The storage system according to claim 2, wherein
the analysis device is configured to
estimate a response time of remote copy based on the information of the first storage system, and
estimate an influence on a processing performance of the first storage system based on the estimated response time of the remote copy.

10. The storage system according to claim 6, wherein
the analysis device is configured to
detect a change in the first storage system, and
analyze an influence on the first storage that has changed.

11. The storage system according to claim 10, wherein
the change of the first storage system is one of a predicted change in an IO amount, a configuration change instruction, and an actually measured change.

12. The storage system according to claim 6, wherein
the influence of the second storage system is an influence on an IO processing performance.

13. A method for analyzing a storage system, the storage system including a first storage system that includes a first processor and a first drive, a second storage system that includes a second processor and a second drive, and a communication device that is capable of communication, wherein
the analysis device analyzes an influence of the first storage system on the second storage system based on information of the first storage system and information of the second storage system that cooperates with the first storage system.
